(19) United States
(12) Patent Application Publication
(10) Pub. No.: US 2007/0137415 A1
(43) Pub. Date: Jun. 21, 2007

(54) Vibration-Cushioned Vehicle Steering Wheel

(76) Inventor: Michael Thomas, Obernburg (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 11/611,618

(22) Filed: Dec. 15, 2006

Related U.S. Application Data
(63) Continuation of application No. PCT/DE05/01088, filed on Jun. 13, 2005.

(30) Foreign Application Priority Data
Jun. 15, 2004 (DE) 20 2004009692.7
Mar. 17, 2005 (DE) 20 2005004649.3

(51) Int. Cl. B62D 1/04; G05G 1/10

(52) U.S. Cl. 74/552

(57) ABSTRACT

The invention relates to a vibration-cushioned vehicle steering wheel comprising a steering wheel carcass and a steering wheel covering, in addition to at least one container, which is located inside the steering wheel and contains at least one displaceable body that acts as a vibration cushion. The aim of the invention is to further improve the vibration cushioning of the steering wheel. To achieve this, vibration damping elements are provided between at least one end face of the body that can be displaced in the direction of its longitudinal axis and the associated end face of the container.

### CROSS REFERENCE TO RELATED APPLICATIONS

This is a continuation of International Application No. PCT/DE2005/001088, filed Jun. 13, 2005, which claims priority from German Application No. DE202004009692.7, filed Jun. 15, 2004, and German Application No. DE202005004649.3, filed Mar. 17, 2005, which are hereby incorporated by reference herein in their entirety.

### FIELD OF THE INVENTION

The invention relates to a vibration-cushioned vehicle steering wheel.

### BACKGROUND OF THE INVENTION

Torsional vibrations of the steering wheel, which are generally triggered by the chassis, lead to unpleasant vibrations for the driver. It is known to cushion torsional vibrations of the steering wheel by means of a rigid additional weight on the steering wheel. However, the additional weight has a disadvantageous effect on other vibratory states of the steering wheel.

Furthermore, DE 200 16 639 U1 discloses a steering wheel in which a vibration-cushioned element is arranged between the steering wheel carcass and the steering wheel rim covering. The rings or a continuous insert which are arranged on the steering wheel rim carcass and support the steering wheel rim covering are preferably made of a vibration-cushioning material or composite material.

EP 1 180 464 A2 discloses a steering wheel, in which a container is arranged within the steering wheel rim, the container containing a weight in the form of a solid body which can move within certain limits in the container and which thereby counteracts vibrations of the steering wheel.

Furthermore, DE 39 27 383 A1 discloses a carcass construction for steering wheels, in which the steering wheel rim is partially filled with a fluid medium. This is intended to reduce the mass moment of inertia of the steering wheel. The steering wheel recoil vibration is to be cushioned and an excessive vibration is to be avoided. A further cushioning effect is to be obtained by the friction between the fluid medium and the inner wall of the steering wheel rim.

The disadvantage of these arrangements is that the solid body or the liquid in the steering wheel rim can move in an uncushioned manner apart from the friction against the container wall or against the wall of the carcass construction, as a result of which the vibration cushioning is impaired.

### SUMMARY OF THE INVENTION

The invention is based on the object of further improving the vibration cushioning on the steering wheel.

According to the invention, this is achieved in accordance with the features described hereinafter.

In the case of a vibration-cushioned vehicle steering wheel with a steering wheel carcass and a steering wheel covering, and with at least one container which is arranged within the steering wheel and in which at least one movable body is arranged as a vibration cushion, according to the invention vibration damping means are provided between at least one end side of the body, which is movable in the direction of its longitudinal axis, and the assigned container end side.

In the case of the arrangement according to the invention, a movable body cannot move in the direction of its longitudinal axis between the end sides of the container in an unimpeded manner but rather its movement is braked by vibration damping means, i.e. the body executes a cushioned vibration.

In one embodiment, a liquid is provided as the vibration damping means. The manner of the cushioning can be set via the weight of the movable body and via the amount of liquid. In one embodiment, the container is completely filled with liquid. The liquid can be composed of one component, for example water, oil or glycerin. However, in order to set a desired vibration damping, it may also be composed of a plurality of components.

For the additional cushioning of the liquids, at least one constriction can be provided in the container. In one embodiment, a plurality of differently sized constrictions are provided.

In a further embodiment, at least one spring element is provided as the vibration damping means. The spring elements can be composed, for example, of metal, rubber or plastic. A further embodiment has both at least one spring element and a liquid. The vibration cushioning can thereby be set within wide limits.

A compressible medium, such as, for example, gas, can also be provided as the vibration damping means.

In a further refinement of the invention, a plurality of containers of differing size are provided. As a result, a relatively great spread of the cushioning can be achieved. This spread can be further expanded by a plurality of movable bodies of differing mass, between which spring elements are arranged, being provided in at least one container, with it possibly being expedient, when there is a plurality of containers, to provide movable bodies of differing mass in each container. In the case of this embodiment too, a liquid can additionally be contained in each container.

When a container is used, it is expedient for it to be arranged in that part of the steering wheel which is at the bottom during straight-ahead travel.

When two containers are used, it is expedient for them to be arranged opposite each other in order to avoid an unbalance.

The containers are arranged in particular in the steering wheel rim, with them preferably being provided in the foam covering of the steering wheel without direct connection to the steering wheel carcass, that is to say, the containers are surrounded on all sides by foam, i.e. do not bear against the steering wheel carcass.

The container can be arranged, for example, at least partially within a U-shaped steering wheel carcass. Furthermore, the container can have different cross sections. It can thus have a circular cross section or a cross section similar to the shape of a trapezoid. In order to obtain a jerk-free movement, the movable body can be mounted on its circumference. It is preferably mounted at least approximately in a pointlike manner, with the bearing points in particular having curved bearing surfaces.

It can be expedient to provide negative pressure in the container for the vibration cushion.

### BRIEF DESCRIPTION OF THE DRAWINGS

The invention is to be explained in exemplary embodiments with reference to drawings, in which:

FIG. 1 shows a longitudinal section through a section of a steering wheel with a movable body arranged with liquid in a container;

FIG. 2 shows a longitudinal section through a section of a steering wheel with a movable body arranged between springs in a container;

FIG. 3 shows a cross section through the steering wheel section along the section line III-III of FIG. 2;

FIG. 4 shows a longitudinal section through a section of a steering wheel with a plurality of movable bodies arranged in a container;

FIG. 5 shows a longitudinal section through a section of a steering wheel with a plurality of containers;

FIG. 6 shows the section according to FIG. 1 with container constrictions;

FIG. 7 shows a cross section through the steering wheel rim along the section line III-III of FIG. 2 with a container cross section which is changed in relation to FIG. 3.

### DETAILED DESCRIPTION OF THE PREFERRED EMBODIMENTS

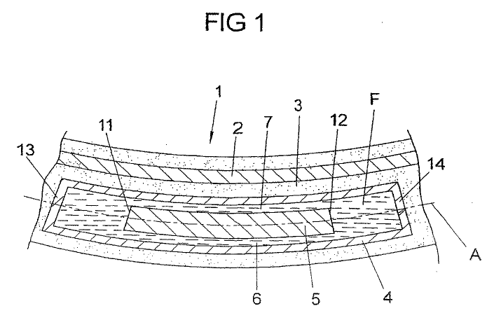

In the embodiment of FIG. 1, a section of a steering wheel rim 1 is illustrated in section. A section of a steering wheel rim carcass 2 and a steering wheel covering 3 can be seen. A container 4 is provided in the steering wheel covering 3, which container is preferably arranged in that part of the steering wheel 1 which is at the bottom during straight-ahead travel, and is curved in accordance with the curvature of the steering wheel rim 1. The arrangement of the container 4 in the bottom part of the steering wheel 1 is expedient if only one container is provided. When two containers are used, it is expedient to arrange them opposite each other, i.e. in that part of the steering wheel which is at the bottom and that part of the steering wheel which is at the top during straight-ahead travel. During the foaming of the

steering wheel covering 3, the container 4 is foamed in place at the same time or, after foaming, is inserted into an opening of the steering wheel covering. A movable body 5 is arranged in the container 4, the movable body having the cross-sectional shape of the container, for example the circular shape, but, in order to ensure mobility, having a smaller diameter than the inside diameter of the container 4. Furthermore, the movable body and also the longitudinal axis A thereof are likewise curved in accordance with the curvature of the container 4. The container 4 is completely filled with a liquid F, for example with water, so that the movable body 5 is surrounded on all sides by the liquid, with the lower section 6 of the gap between the movable body 5 and the inner wall of the container 4 being smaller because of the gravitational force acting on the movable body 5 than the upper section 7 of the gap between the movable body 5 and the inner wall of the container 4.

When vibrations occur on the steering wheel, the movable body 5 can move in the direction of its longitudinal axis A. However, its movement is cushioned on account of the liquid surrounding the movable body 5 and in particular on account of the liquid situated between the end surfaces 11, 12 and the container end sides 13, 14. In this case, the manner of the cushioning is set by the weight of the movable body and by the amount of liquid, that is to say, also by the length of the container, and also by the gap between the movable body 5 and the inner wall of the container 4. Owing to the improved cushioning properties of this system in comparison to a freely movable body, a relatively small movable body can be selected, thus reducing the increase in weight due to the movable body.

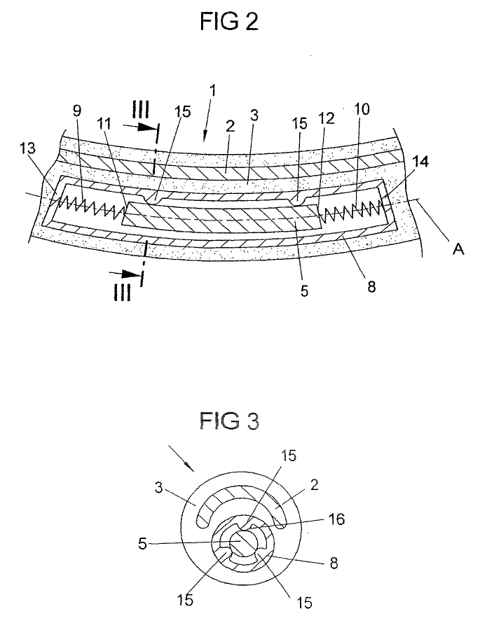

In the embodiment of FIGS. 2 and 3, a container 8 is provided in the steering wheel covering 3, in which container the movable body 5 is arranged between two springs 9, 10 which extend between the end surfaces 11, 12 and the associated container end sides 13, 14. In the case of this embodiment too, the movable body 5 is curved in accordance with the curvature of the container 8 and of the steering wheel rim 1. In this embodiment, the movable body 5 is mounted in a virtually pointlike manner at bearing points 15 which have curved bearing surfaces 16, so that only small frictional forces are in effect and the movable body 5 is therefore easily movable in the direction of its longitudinal axis A. However, the springs 9, 10 cushion the movement of the movable body 5 in the direction of its longitidunal axis A in a similar manner to the

liquid in the embodiment of FIG. 1. In this embodiment, the vibration frequency of the movable body 5 is set via the spring strength and the mass of the movable body.

It is apparent from FIG. 3 that the container 5 in this embodiment partly lies within the U-shaped steering wheel rim carcass 2 and that, in the sectional plane illustrated, three bearing points 15 are provided at an angular spacing of 120°. Also, three bearing points are provided in the bearing region illustrated by the bearing point 15 on the right in FIG. 2.

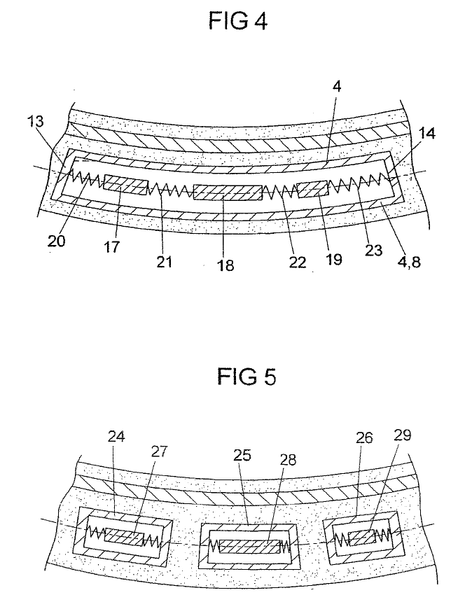

In the embodiment of FIG. 4, three movable bodies 17, 18, 19 are provided in a container which can be in the shape of the container 4 or the container 8. In the embodiment of the container 4, said bodies are surrounded by liquid. In the embodiment of the container 8, said bodies are mounted in a pointlike manner on their circumference like the movable body 5 of FIGS. 2 and 3. This mounting is not illustrated in FIG. 4. However, it is also possible that the container 8 is additionally filled with a liquid as in the embodiment of FIG. 1. The movable bodies 17, 18, 19 have differing size and mass. A spring 20 is arranged between the container end side 13 and the movable body 17. Respective springs 21 and 22 are provided between the movable bodies 17, 18 and 18, 19. Furthermore, it can be seen that a spring 23 is arranged between the container end side 14 and the movable body 19.

In this embodiment of FIG. 4, a greater spread of the cushioning can be obtained than in the embodiments of FIGS. 1 to 3, since the movable bodies can have differing size and mass and springs having a different spring constant can be used.

The embodiment of FIG. 5 provides a plurality of containers 24, 25, 26 in which a movable body 27, 28, 29 is respectively arranged. Said movable bodies can be mounted in a pointlike manner as per the embodiments of FIGS. 2-4, and/or can be arranged in a liquid. Springs are provided between each movable body and the associated end surfaces of the containers, which springs are illustrated schematically in FIG. 5 but are not identified specifically, since their arrangement corresponds to that illustrated in FIG. 2.

In the case of the arrangement of FIG. 5, an even greater spread of the cushioning can be obtained than in the case of the embodiment of FIG. 4, since, in addition to movable bodies of differing mass and springs of a different spring constant, it is also possible to use liquids of differing viscosity, such as, for example, water, oil, glycerin or a mixture of these liquids.

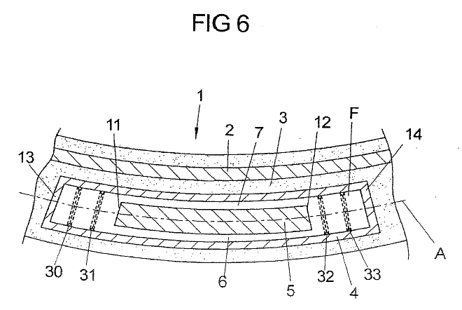

In order to further improve the cushioning, the embodiment of FIG. 6 provides constrictions 30 to 33 which extend annularly from the container inner wall into the container 4. In the embodiment illustrated, the constrictions 30 and 33 are larger than the constrictions 31 and 32.

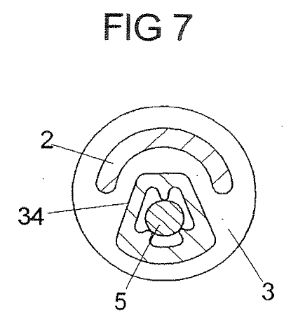

In the case of the embodiment of FIG. 7, the container 34 has a cross section approximate to the shape of a trapezoid. Furthermore, it can be seen that the container 34 is partially arranged within the U-shaped steering wheel rim carcass 2.

What is claimed is:

1. A vibration-cushioned vehicle steering wheel with a steering wheel carcass and a steering wheel covering, and with at least one container which is arranged within the steering wheel and in which at least one movable body is arranged as a vibration cushion, characterized in that vibration damping means are provided between at least one end side of the body, which is movable in the direction of its longitudinal axis, and the assigned container end side.

2. The vehicle steering wheel as claimed in claim 1, characterized in that a liquid is provided as the vibration damping means.

3. The vehicle steering wheel as claimed in claim 2, characterized in that the container is completely filled with liquid.

4. The vehicle steering wheel as claimed in claim 2, characterized in that the liquid is composed of a plurality of components.

5. The vehicle steering wheel as claimed in claims 2, characterized in that, for the additional cushioning of the liquids, at least one constriction is provided in the container.

6. The vehicle steering wheel as claimed in claim 5, characterized in that a plurality of differently sized constrictions are provided.

7. The vehicle steering wheel as claimed in claim 1, characterized in that at least one spring element is provided as the vibration damping means.

8. The vehicle steering wheel as claimed in claim 7, characterized in that the spring elements are composed of metal, rubber or plastic.

9. The vehicle steering wheel as claimed in claim 1, characterized in that a compressible medium is provided as the vibration damping means.

10. The vehicle steering wheel as claimed in claim 9, characterized in that gas is provided as the compressible medium.

11. The vehicle steering wheel as claimed in claim 1, characterized in that, when a container is used, it is arranged in that part of the steering wheel which is at the bottom during straight-ahead travel.

12. The vehicle steering wheel as claimed in claim 1, characterized in that, when two containers are used, they are arranged opposite each other.

13. The vehicle steering wheel as claimed in claim 1, characterized in that a plurality of containers of differing size are provided.

14. The vehicle steering wheel as claimed in claim 1, characterized in that a plurality of movable bodies of differing mass, between which spring elements are arranged, are provided in at least one container.

15. The vehicle steering wheel as claimed in claim 1, characterized in that, when there is a plurality of containers, movable bodies of differing mass are provided in each container.

16. The vehicle steering wheel as claimed in claim 1, characterized in that the at least one container is arranged in the steering wheel rim.

17. The vehicle steering wheel as claimed in claim 16, characterized in that the container is arranged without direct connection to the steering wheel carcass.

18. The vehicle steering wheel as claimed in claim 16, characterized in that the container is arranged in the foam covering of the steering wheel.

19. The vehicle steering wheel as claimed in claim 16, characterized in that the container is at least partially arranged within a U-shaped steering wheel carcass.

20. The vehicle steering wheel as claimed in claim 16, characterized in that the container has a circular cross section.

21. The vehicle steering wheel as claimed in claim 16, characterized in that the container has a cross section similar to the shape of a trapezoid.

22. The vehicle steering wheel as claimed in claim 1, characterized in that the movable body is mounted on its circumference.

23. The vehicle steering wheel as claimed in claim 22, characterized in that the movable body is mounted at least approximately in a point-like manner.

24. The vehicle steering wheel as claimed in claim 22, characterized in that the bearing points have curved bearing surfaces.

25. The vehicle steering wheel as claimed in claim 1, characterized in that negative pressure is provided in the container for the vibration cushion.
